(19) United States
(12) Patent Application Publication
(10) Pub. No.: US 2008/0294599 A1
(43) Pub. Date: Nov. 27, 2008

(54) APPARATUS AND METHOD OF SEMANTIC TUPLESPACE SYSTEM

(75) Inventors: Hui Lei, Scarsdale, NY (US); Liangzhao Zeng, Mohegan Lake, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: INTERNATIONAL BUSINESS MACHINES CORPORATION, Armonk, NY (US)

(21) Appl. No.: 11/752,317

(22) Filed: May 23, 2007

(51) Int. Cl. G06F 17/30

(52) U.S. Cl. 707/3; 707/E17.108

(57) ABSTRACT

A tuple matching method and system includes conducting a plurality of types of matching techniques. The system and method conducts both semantic tuple matching and correlation tuple matching.

### BACKGROUND OF THE INVENTION

1. Field of the Invention

The present invention generally relates to tuplespace communication systems, and more particularly to a method and apparatus that enables semantic tuple matching.

2. Description of the Related Art

The tuplespace paradigm is a simple, easy to use, and efficient approach for supporting cooperative communication among distributed services. Typically, a tuplespace system contains three roles: (i) tuple writers, who write tuples into sharespace, (ii) tuple readers, who read/take tuples that they are interested in, by specifying templates, and (iii) the tuplespace server, who is responsible for managing the sharespace and routing the tuples from writers to readers.

The earliest tuplespace systems were type-based. A tuple in certain conventional systems includes a series of typed fields. For example, a tuple can be t(‘Sports Car’, 400,000). Tuple matching is based on a template that consists of a series of typed fields or type definitions. For instance, a template can be j(<‘Sports Car>]), <? Float>), where typed field (e.g., <‘Sports Car’>) requires value identical matching (e.g., string that is the same as ‘Sports Car’); while the type definition (e.g., <? Float>) only concerns the type matching (e.g., any float value). Obviously, such systems have limitations on specifying filtering criteria (i.e., either exact value or type matching). For above example, any tuples with type float in the second field can satisfy the template's requirement on second field, regardless of the value of the field.

Consequently, as an improvement to type-based solutions, object-based tuplespace systems have been proposed. Instead of exact type matching, these systems enable object compatibility based type matching. Further, these systems allow tuple readers to specify queries on fields, which provides the flexibility of choosing filtering criteria along multiple dimensions.

For example, the template in the vehicle dealer example may be refined as j′(<SportsCar>, <CarInsurance, CarInsurance.premium<2000>). This template indicates that those tuples that first field's type is SportsCar or descendent of SportsCar (e.g., USSportsCar, if USSportsCar is a descendent class of SportsCar in the implementation of the class hierarchy) and the second field's type is CarInsurance or descendent of CarInsurance and the premium is less than 2000, will be delivered to the reader.

Considering the adaptability and flexibility requirements from services that operate in dynamic environments, the inventors of the present invention have discovered that both type-based and object-based tuplespace systems are not sufficient in at least the following two aspects.

The first is value-based matching. Currently, in object-based tuplespace systems, the type matching is based on object compatibility, wherein the relationship among the objects is deduced from the implementation of the class hierarchy. The inventors of the present invention have discovered that without semantic support to understand the meaning of the field, the matching algorithm assumes that both tuple writers and readers share the same implementation of class hierarchy. Such an assumption is hard to enforce when the relationship of tuple writers and readers is dynamically formed.

The second is one-to-one matching. Presumably, services read multiple tuples in a transaction as no single tuple can provide all the necessary fields, when they interact with a collection of partner services. The inventors of the present invention have discovered, however, that in current tuplespace systems, correlation of interrelated tuples is not supported, which requires custom implementation by application programmers. The implementation of tuple correlation is often a challenging and involving task. Further, it requires that the application programmers be aware of all the tuples that are provided by partner services in advance at development time. Such a requirement is impractical when a service has a dynamic collection of partners.

### SUMMARY OF THE INVENTION

In view of the foregoing and other exemplary problems, drawbacks, and disadvantages of the conventional methods and structures, an exemplary feature of the present invention is to provide a semantic tuplespace system (and method).

In accordance with a first aspect of the present invention, a tuple matching method includes conducting a plurality of types of matching techniques.

In accordance with a second aspect of the present invention, a tuple matching system, includes a matching unit that conducts a plurality of types of matching techniques.

In accordance with a third aspect of the present invention, a computer-readable medium tangibly embodies a program of computer-readable instructions executable by a digital processing apparatus to perform a tuple matching method, where the tuple matching method includes conducting a plurality of types of matching techniques.

The system (and method) of the present invention uses ontologies to understand the semantics of tuple contents, and correlates tuples using relational operators as part of tuple matching. Therefore, by engineering ontologies, the present system (and method) allows different services to exchange information in their native formats. A semantic tuplespace system (and method) of the present invention enables flexible and on-demand communication among services.

As indicated above, certain aspects of the present invention are directed to a semantic tuplespace system, which enables semantic tuple matching, wherein semantic knowledge is maintained in ontologies. This releases the constraints in object-based tuplespace systems that writers, readers and the server must share the same implementation of class hierarchy. Unlike conventional tuplespace systems, tuple correlation in the system (and method) of the present invention is performed by the tuplespace server, which is transparent to tuple readers. Therefore, services in dynamic environments become easier to develop and maintain as tuple semantic transformation and correlation can be provided as part of the tuplespace system.

Accordingly, the system (and method) of the present invention provides efficient semantic tuple matching. A naive approach to enabling semantic tuple matching is term generation, in which more generic fields (i.e., objects) are generated based on ontologies. For example, from an object of sportsCar, the system can generate a more generic object about car. Such an approach is clearly very inefficient, since it generates unnecessary redundant tuples. In accordance with certain exemplary aspects of the present invention, instead of adopting term generation approach, the system enables semantic tuple routing by rewriting templates, wherein no redundant tuples need to be generated.

Furthermore, as indicated above, the system (and method) of the present invention provides semantic-based, correlation matching. With ontology support, it is possible for the system to conduct tuple correlation based on tuple content semantics using relational operators. For example, two tuples in a sharespace can be correlated to one by the join operator and then delivered to tuple readers. In accordance with one aspect of the present invention, tuple matching is extended in traditional tuplespace systems with two kinds of correlation matchings, namely those based on common fields across tuples and those based on attribute dependence. Correlation matching can automatically search available tuples which can only provide partial information required by a read/take template, and correlate them to one tuple that contains all the fields required by the template.

As indicated above, the inventors of the present invention have discovered that conventional tuplespace systems are inadequate for supporting communication among services in heterogeneous and dynamic environments, because services are forced to adopt the same approach to organizing the information exchanged. The semantic tuplespace system (and method) of the present invention overcomes the limitations and constraints of the conventional systems. Further, by introducing semantics into to the system the constraint on one-to-one mapping between the tuple and read/take request is also released. By correlation multiple tuples into one, information from multiple can be correlated to one and delivered to the service requesters.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a dependence tree for exemplary class C;

FIG. 2 illustrates an architecture of a semantic tuplespace system 200, in accordance with an exemplary embodiment of the present invention;

FIG. 3 illustrates a system architecture of a tuplespace server 300, in accordance with an exemplary aspect of the present invention;

FIG. 4 illustrates an example of the data organization of the tuples and contents of the tuples in an exemplary system of the present invention;

FIG. 5 illustrates an exemplary hardware/information handling system 500 for incorporating the present invention therein; and

FIG. 6 illustrates a signal bearing medium 500 (e.g., storage medium) for storing steps of a program of a method according to the present invention.

### DETAILED DESCRIPTION OF EXEMPLARY EMBODIMENTS OF THE INVENTION

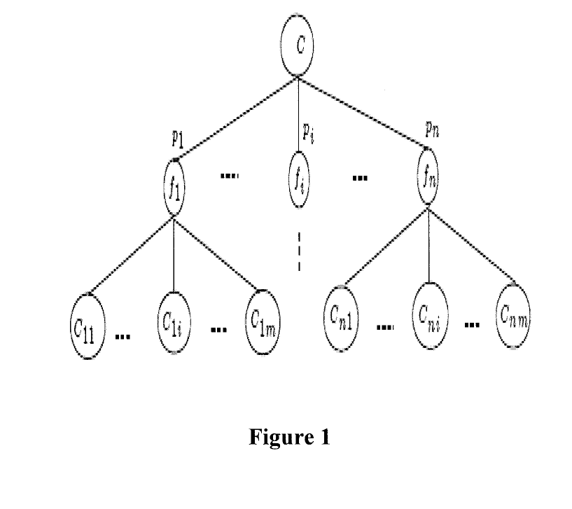

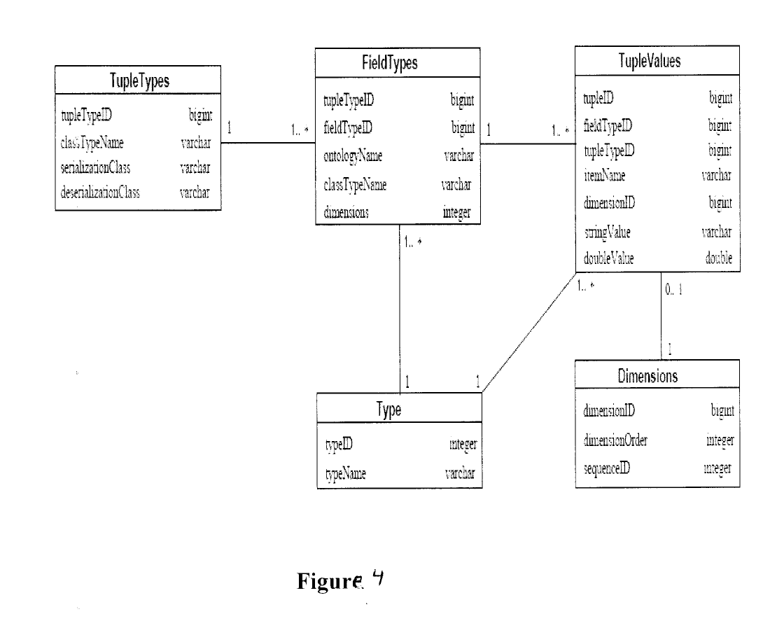

Referring now to the drawings, and more particularly to FIGS. 1-6, there are shown exemplary embodiments of the method and structures according to the present invention.

In a system in accordance with certain exemplary aspects of the present invention, an object-oriented approach is adopted to the definition of ontology, in which the type is defined in terms of classes and an instance of a class is considered as an object.
A class C may be defined as the tuple C=<N,S,P,R,F>, where N is the name of the class;
S is a set of synonyms for the name of class, S={s1, s2, . . . , sn};
P is a set of properties, P={p1, p2, . . . , pn}. For pi ε P, pi is a 2-tuple in form of <T,Np>, where T is a basic type such as integer, or a class in an ontology, Np is the property name;
R is a set of parent classes, R={C1, C2, . . . , Ck};
F is a set of dependence functions for the properties, F={f1, f2, . . . , f1}. Each function is in form of f₂(p₁′, p₂′, . . . , pₘ′) and associated with a predicate c, where the output of fj is a property pi of class C and pᵢ′ is property from a class other than C and the predicate c is used to correlate pᵢ′

In the definition of class, the name, synonyms, and properties present the connotation of a class; while parent classes and dependence functions specify relationships among the classes (i.e., present the denotation of a class). In particular, dependence functions provide information for searching candidate tuples for correlation. A class may have parent classes for which it inherits attributes. For example, class sportsCar's parent class is Car, so the class sportsCar inherits all the attributes in class Car.

Other than inheritance relationships, different classes may have value dependence on their properties. In certain exemplary embodiments of the system of the present invention, dependence functions may be used to indicate the value dependence among the different classes' properties. For example, if there may be three classes ShippingDuration, Arrival and Departure. In ShippingDuration, the attribute duration has a dependence function minus(Arrival.timeStamp, Departure.timeStamp), where the predicate is ShippingDuration. shippingID=Arrival. shippingID=Departure. shippingID.

Based on dependence functions, a dependence tree can be constructed for each class. Assuming that the class C has a set of dependence functions F, a dependence tree can be generated as in FIG. 1. There are three kinds of nodes in a dependence tree, namely class node, operator node and dependant class node. It should be noted that the depended class node may also have its own dependence tree (e.g., C₁₁) A class C's complete dependence set (denoted as D_{C}) is defined as a collection of depended classes that can be used to calculate the value of the property. For example, the set {C11, C12, . . . , C1m} is a complete dependence set of the class C's property P₁.

Once a class is defined, instances of the class can be created as objects (e.g., see the definition of an object below). In the definition, the ID is the universal identifier for an object, while V gives values of attributes in the object.

An object o is a 3-tuple <ID,Nc, V>, o is an instance of a class C, where
ID is the id of the object;
Nc is the class name of C;
V={v1, v2, . . . , vn}, are values according to the attributes of the class C. For vi ε V, vi is a 2-tuple in form of <Np, Vp>, where Np is the property name, Vp is the property value.

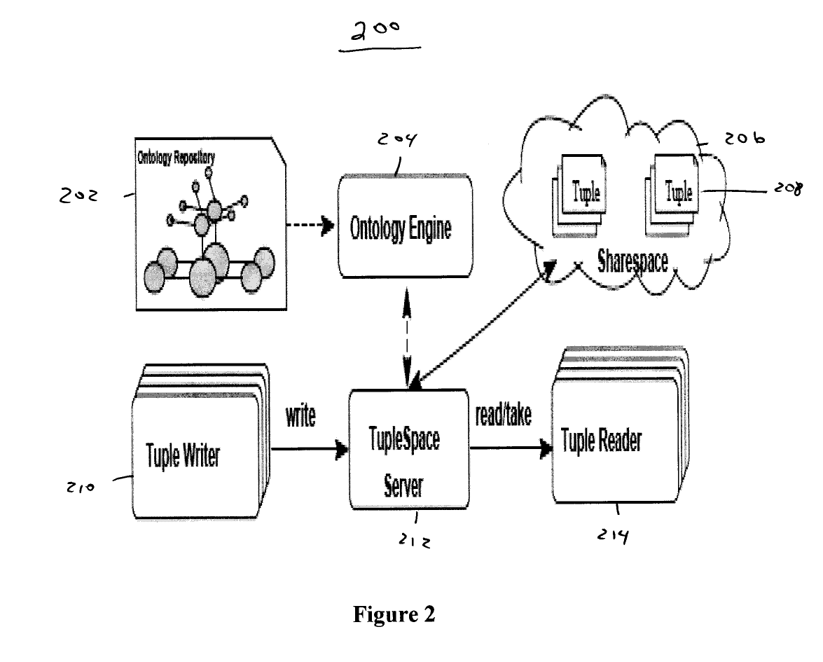

The semantic tuplespace system 200 of the present invention, as exemplarily depicted in FIG. 2, may include an ontology repository 202, an ontology engine 204, tuple writers 210, tuple readers 214, a sharespace 206 for tuples 208 and a tuplespace server 212. A tuple 208 in the semantic tuplespace system 200 is denoted a t(o₁, o₂, . . . , oₙ), where each field in a tuple 208 is an object oᵢ¹ and the class is Cᵢ. An example of a tuple can be tₛ (sportsCarA, carInsuranceB, carFinanceC), which contains three objects.

The basic operations in semantic tuplespace include write, read and take. For tuple providers, the write operation is used to save tuples into the sharespace. For tuple consumers, the operations can be either read or take. The difference between read and take is that after a take, the tuple is removed from the sharespace, while read leaves the tuple object in sharespace.

TABLE 1
Notations

| Notation | Definition |
|---|---|
| C | a class |
| C | a set of classes |
| pᵢ | a class property |
| fᵢ | a dependency function |
| [symbol] | a complete dependence set for class C |
| o | an object |
| t(o1, o2, . . . , on) | a tuple |
| [symbol] | the set consists of all t's field |
| | classes |
| T | a set of tuples |
| [symbol] | the set consists of all field classes |
| | of tuples in T |
| φ (t1, t2, . . . , tn) | a read/take template |
| [symbol] | the set consists of all the field |
| | classes required by template φ |
| qᵢ | a query predicate |
| tᵢ=<Cᵢ, qᵢ> | a formal field in template |

Table 1, above, provides a list of notations used in the description, above and throughout this application.

When performing a read/take operation, a template φ(t1, t2, . . . , tn) that defines tuple matching conditions is specified. For each tᵢ in φ, it can be either a formal or a non-formal field. A formal field is specified as a pair <Cᵢ, qᵢ>, where the Cᵢ specifies the class of the field and the qᵢ is a query predicate (a boolean expression of attributes in class Cᵢ). A non-formal field is specified as <oᵢ> that indicates expecting an identical object as oᵢ is contained in matched tuples. There are two options in read/take operation, which include all or any. Option “all” returns all the matched tuples, while option “any” only returns one of the matched tuples.

An example of template can be jₛ (e.g., see Table 2 below). In this example, the first field required by the template is an object of class Car, where the associated query predicate is Car.price.amount<5000.

The second field is non-formal. Object carlnsuranceB, indicates that the tuples need to provide identical information as specified in the object. Actually, the non-formal field <oᵢ> can be converted to a formal field as <C′, [symbol] ₌₀(C′·pⱼ=oᵢ·ⱼ)> where object oᵢ's class is C′ that has n properties pⱼ.

TABLE 2
Examples

| Entity | Example |
|---|---|
| template | φₛ(<Car, Car.price.amount < 5000>, |
| | <carInsuranceB>, <CarFinance, null>) |
| candidate tuple | t(sportsCarA, carInsuranceB, |
| | carFinanceC) |
| tuple set | Tₖ = {t₁, t₂}, where |
| | t₁(sportsCarA, sportsCarInsuranceB), |
| | t₂(sportsCarA, carFinanceC) |
| generated template for t₁ | φ₁(<sportsCar, |
| | SportsCar.price.amount < 5000>, |
| | <carInsuranceB>) |
| generated template for t₂ | φ₂(<sportsCar, |
| | SportsCar.price.amount < 5000>, |
| | <CarFinance, null>) |
| tuple set | T_{f} = {t₁, t₂, t₃, t₄ }, where |
| | t₁(sportsCarA, licenceB), t₂(licenceB, |
| | carOwnerC), |
| | t₃(carOwnerC, carInsuranceD), t₄ |
| | (sportsCarA, carFinanceE) |

By introducing ontologies into tuplespace system, other than exact matching, the tuple matching algorithm is extended with two extra steps in the method and system of the present invention. The additional steps include semantic matching and correlation matching. Therefore, three steps are involved in the matching algorithm of the present method and system.

The first step is to find exact matches, which returns tuples that have exactly the same field classes as the template. The second step includes semantic matching, where the system searches tuples that have field classes which are semantically compatible with the template and delivers tuples if the tuples' contents can satisfy the filtering conditions. The third step includes correlation matching where the system searches a set of tuples and correlates them to one tuple, in order to match all required fields of the template.

The conventional type-based tuplespace systems only perform step 1. The object-based tuplespace systems perform another step of matching that is based on object compatibility, which is different from the above semantic matching. In an object-based tuplespace system, the object compatibility is deduced from the implementation of class hierarchy. In the semantic tuplespace system of the claimed invention, the relationships among the objects are declaratively defined by ontologies. As such, the above semantic matching and correlation matching are unique to the semantic tuplespace system of the present invention.

For purposes of the present discussion, it is assumed that both readers and writers use the same ontology for a domain. If a tuple writer and a tuple reader use different ontologies for a domain, then a common ontology can be created for both writer and reader. Therefore, by engineering ontologies, the present system allows different services to exchange information using their native information format to construct tuples. The cost of engineering ontologies is much less than that of developing object adaptors for object-based tuplespace systems as ontologies are declaratively defined. Further, ontologies are reusable.

As an extension of the object-based tuplespace system, semantic matching is used to determine whether a tuple in the sharespace satisfies a tuple retrieval request (read/take). The difference between object-based matching and semantic matching comes from the adopted approaches that determine the relation among the objects. As discussed above, object-based matching tuple matching is based on object compatibility, where the subclass relation is deduced from the implementation of class hierarchy. This requires all the tuplespace users to adopt the same implementation of class hierarchy. In the semantic matching of the present invention, the system adopts the notion of semantic compatibility, wherein the semantic knowledge of synonyms and subclasses can be declaratively defined in ontologies.

Class Cᵢ is semantically compatible with class Cⱼ, denoted as

$${C}_{i}^{s} = {C}_{j} ,$$

if in the ontology, either (i) Cᵢ is the same as Cⱼ (same name or synonym in an ontology), or (ii) Cⱼ is a superclass of Cᵢ.

By adopting this definition of semantic compatibility, a class C semantically belongs to a class set

[symbol]

(denoted as C εₛ [symbol] ) if

$$∃ {C}_{i} ∈ ℂ , C {=}^{s} {C}_{i} , .$$

Using the notion of semantic compatibility, a candidate tuple is defined as a tuple that contains all the fields that are semantically compatible with the fields required by a read/take operation. In the definition, each of the fields of the tuple needs to be semantically compatible with the corresponding field of the template. For example (see Table 2), with regard to the template jₛ, the tuple t can provide all the fields required in jₛ since the first field sportsCarA “is a” Car (semantic compatibility) and the rest two fields are exactly matched. Therefore, t is a candidate tuple for jₛ.

t is a tuple in tuplespace where Cₜ is the set that contains all the field classes in t; φ is the template for read or take operation, where the field class set is

[symbol]

t is a candidate tuple for φ iff: ∀Cᵢ ε

[symbol]

### Cᵢ εₛ

It is noted that a candidate tuple may not be able to satisfy the filtering condition given in templates. Further examination of the contents of the tuple may be required, in order to determinate whether the tuple should be delivered to the tuple readers.

In the system of the present invention, when inspecting the contents of tuples, in most cases, the tuplespace server may rewrite fields in the template, except when all the field classes in the candidate tuple are exactly the same as those of the template, i.e., [symbol] . Therefore, each <Cᵢ,qᵢ> in φ, assuming the class type of candidate tuple is C′ for the corresponding field, should be rewritten as

[symbol]

C′, qᵢ′ [symbol]
where qᵢ is transformed from qᵢ by replacing property references of class type C with C′.

As a further extension of object-based tuple matching, the present system also enables correlating multiple tuples for a template.

In the framework of the present method and system, multiple tuples in the sharespace can be correlated to one that can provide all the necessary fields required by a template, wherein the correlation can be done by the join operator. Correlation can be either based on common fields and/or attribute dependence functions.

Multiple tuples can be correlated using the join operator to one if they contain same field. For example, two tuples t₁ and t₂ in

[symbol]

(see Table 2) can be correlated using the join operator as they both have field sportsCarA. Therefore, when the tuplespace server performs the correlation matching, in order to compose tuples that can provide all the fields that are required by the template, it first searches a key-based correlation tuple set (i.e., a set of tuples that are correlatable by a key field that is specified by the template and can provide all the fields required by the template). The formal definition of key-based correlation tuple set is as follows:

[symbol] ( [symbol] ={t₁,t₂, . . . , tₙ}) is a set of tuples in tuplespace, [symbol] is the set that consists of all the field classes in tuple tᵢ and

$${ℂ}_{𝕋} ( {ℂ}_{𝕋} = {{⋃}_{i = 1}}^{n} {ℂ}_{{t}_{i}} )$$

is aggregation of all the field classes in [symbol] ; φ is the template for read/take operation, Cₖ is the key field's class type and [symbol] is the set that consists of all the field classes of φ. [symbol] is a key-based correlation tuple set of φ iff:
1. ∀C ε [symbol] , C εₛ [symbol] ;
2.

$$∀ {ℂ}_{{t}_{i}} , ∃ {C}_{k}^{′} ∈ {ℂ}_{{t}_{i}} , {C}_{k} {=}^{s} {C}_{k}^{′}$$

and o₁^{k}=o₂^{k}= . . . =oₙ^{k}, where oᵢ^{k} is the field with class Cₖ′ in tᵢ;
3.

$${}_{}^{″}{ℂ}{}_{{t}_{i}}^{} , . ℂ , ∀ {ℂ}_{{t}_{i}} , ∃ C , C ∈ ( {ℂ}_{{t}_{i}} - ( {⋃}_{j = 1}^{i - 1} {ℂ}_{{t}_{j}} ⋃ {⋃}_{j = i + 1}^{n} {ℂ}_{{t}_{j}} ) )$$

### and C εₛ .

In this definition, three conditions should be satisfied when considering a set of tuples as a correlation tuple set for a read/take template: (i) condition (1) indicates for each field class required by the template, there is at least one tuple that contains a compatible field class, which is a necessary condition of the definition; (ii) condition (2) implies all the field classes are correlatable by the key field; and (iii) condition (3) evinces any tuples in the set contributes at least one unique field. Conditions (2) and (3) are the sufficient conditions for the definition. Using the above example, the aggregation of t₁ and t₂ provides all the required fields in template, which satisfy condition (1), and they can be correlated as they share the field sportsCarA that is the descendant for the key field Car in template jₛ. Also, t₁ (resp. t₂) provides unique field carlnsuranceB (resp. carFinanceC). Therefore, t₁ and t₂ compose a key-based correlation tuple set for the template.

By releasing the constraint that correlating is based on key field only, the present system enables more generic tuple correlation, wherein tuple correlations can be based on any fields. In such a generic correlation, the present system adopts the notion of a correlatable class. In a correlatable class, two field classes are correlatable in a set of tuples if either they appear in the same tuple, or when these two classes do not appear in the same tuple and belong to two tuples tₓ and t_{y} respectively, then either (i) tₓ and t_{y} at least have one field that is identical; or (ii) there are a sequence tuples in the set that are correlatable “step by step” and aiming for correlating tₓ and t_{y} in the end. If tₓ and t_{y} are considered entities in an ER model, then these tuples between tₓ and t_{y} in the sequence are relationships. In order to joint two entities without common attributes, a collection of relationships [tₓ₊₁, tₓ₊₂, . . . t_{y-1}] are required. For example, class SportsCar and CarInsurance are correlatable in T_{f} (see Table 2), as class SportsCar and CarInsurance appear in t₁ and t₃ respectively; and t₂ is considered as a relationship to bridge SportsCar and CarInsurance.

Class Cᵢ, Cⱼ are correlatable in tuple set

[symbol]

( [symbol] ={t1, t2, . . . , tn}), iff either
Cᵢ and Cⱼ appear in same tuple (i.e., ∃tₓ ε [symbol] , both Cᵢ and Cⱼε [symbol] ); or
Cᵢ and Cⱼ do not appear in same tuple (i.e., [symbol] ε [symbol] , where Cᵢ and Cⱼε [symbol] ), then ∃tₓ, t_{y} ε [symbol] Cᵢ ε [symbol] , Cⱼ ε [symbol] , and either:
$oₓ from tₓ and $o_{y} from t_{y}, oₓ=o_{y}; or
there is a correlation tuples sequence [tₓ, tₓ₊₁, tₓ₊₂, . . . t_{y-1}, t_{y}] in T, and for any tᵢ, tᵢ₊₁ in the sequence, oᵢ from tᵢ and $oᵢ₊₁ from tᵢ₊₁, so that oᵢ=oᵢ₊₁.

[symbol] ( [symbol] ={t1, t2, . . . , tn}) is a set of tuples in tuplespace, [symbol] is the set that consists of all the field classes in tuple tᵢ and [symbol] ( [symbol] = [symbol] ) is aggregation of all the field classes in T; φ is the template for read/take operation, and [symbol] _{φ} is the set that consists of all the field classes of φ. T is a field-based correlation tuple Set of φ iff:
1. ∀C ε [symbol] , C εₛ [symbol] ;
2. for

$$∀ {C}_{i}^{′} , {C}_{j}^{′} ∈ {ℂ}_{ϕ} , i \neq j , ∃ {C}_{i} , {C}_{j} ∈ {ℂ}_{𝕋} , {C}_{i}^{′} {=}^{s} {C}_{i} , {C}_{j}^{′} {=}^{s} {C}_{j} , ,$$

and Cᵢ and Cⱼ are correlatable in [symbol]
3. ″tᵢOT, at lease one of the following is true:
∃C ε ( [symbol] −( [symbol] [symbol] [symbol] [symbol] )), C εₛ [symbol]
   ;
tᵢ appears in tuple consequences in condition (2) of this definition.

Using the notion of correlatable class, the concept of field-based correlation tuple set may be defined. In the definition, there are also three conditions that need to be satisfied when considering a set of tuples as a correlation tuple set for a read/take template: (i) the same as key-based correlation, condition (1) indicates for each field class required by the template; (ii) different from key-based correlation, instead, Condition (2) implies correlation can be on any fields; and (iii) condition (3) evinces any tuples in the set contributes at least one unique field, either contributes to the required fields by the template, or appears in tuple sequence for correlation.

Other than field-based, multiple tuples can be correlated using dependence functions, in case some required fields can not be provided by any available tuples. Assuming that an absent field's class Cᵢ has a dependence function, the tuplespace server can compute the value for the absent field from the tuples that provide elements in the dependence set. For example, if the class type ShippingDuration is required by the template but not provided by any tuples, as ShippingDuration's dependence set is {Departure, Arrival}, the system can search tuples that contain Departure or/and Arrival and correlate these tuples and compute the value for ShippingDuration. Again, only the correlation on key field is first limited, wherein a key-based attribute-dependence correlation tuple set can be defined as:

[symbol] ( [symbol] ={t1, t2, . . . , tn}) is a set of tuples in tuplespace, [symbol] is the set that consists of all the field classes in tuple tᵢ and

[symbol]

( [symbol] = [symbol] ) is aggregation of all the field classes in T; φ is the template for read/take operation, the key field's class is Cₖ and [symbol]
is the set that consists of all the field classes in φ. [symbol] is a key-based attribute-dependence correlation tuple set of the template φ iff:
1. ∀Cᵢ ε [symbol]
   , either

$$if {C}_{i} {∈}_{s} {ℂ}_{𝕋} , i . e . , ∃ {C}_{i}^{′} ∈ {ℂ}_{𝕋} , {C}_{i} {=}^{s} {C}_{i}^{′} ; or$$

or
if Cᵢ ∉ₛ [symbol] , then [symbol] contain a a complete dependence set

[symbol]

### of Cᵢ.

2.

$$∀ {ℂ}_{{t}_{i}} , ∃ {C}_{k}^{′} ∈ {ℂ}_{{t}_{i}} , {C}_{k} {=}^{s} {C}_{k}^{′} ,$$

and o₁^{k}=o₂^{k}= . . . =oₙ^{k}, where oᵢ^{k} is the field with class Cₖ′ in tᵢ;
3. ∀tᵢ ε [symbol] , at lease one of the following is true:

$$∃ C ∈ ( {ℂ}_{{t}_{i}} - ( {⋃}_{j = 1}^{i - 1} {ℂ}_{{t}_{j}} ⋃ {⋃}_{j = i + 1}^{n} {ℂ}_{{t}_{j}} ) ) , \\ C {∈}_{S} {ℂ}_{ϕ} or C ∈ {𝔻}_{{C}_{i}} ;$$

tᵢ appears in tuple consequences in condition (2) of this definition.

In condition (1) of above definition, unlike field-based correlation tuple set, a field required by the template may not appear in any tuple, however, its properties can be computed using dependence functions. Like field-based correlation in tuple set, the condition (2) concerns whether tuples can be correlated by the key field. The condition (3) states that each tuple in the set contributes at least one unique attribute. Again, the constraint that correlation is based on key-field only can be released. Therefore, the more generic attribute-dependence correlation tuple set can be defined. In particular, the condition 2 of the definition indicates that correlation can be done based on any fields.

[symbol] ( [symbol] ={t1, t2, . . . , tn}) is a set of tuples in tuplespace, [symbol] is the set that consists of all the field classes in tuple tᵢ and [symbol] ( [symbol] [symbol] ) is aggregation of all the field classes in [symbol] ; φ is the template for read/take operation; Cⱼ is the set that consists of all the field classes in φ. [symbol] is an attribute-dependence correlation tuple set of the template φ iff:

1. ∀Cᵢ ε [symbol] , either

$$if {C}_{i} ∈ {ℂ}_{𝕋} , i . e . , ∃ {C}_{i}^{′} ∈ {ℂ}_{𝕋} , {C}_{i} {=}^{s} {C}_{i}^{′} ; or$$

if Cᵢ ∉ₛ [symbol] , then [symbol] contains a complete dependence set [symbol] of Cᵢ.

2. Assuming C′ is the class set for all the Cᵢ′ in condition 1 of this definition, also assuming [symbol] =U [symbol] for all Cᵢ ∉ₛ [symbol] , and [symbol] = [symbol] U [symbol] , then for Cᵢ, Cⱼ □C, Cᵢ and Cⱼ are correlatable in

[symbol]

3. ∀tᵢ ε [symbol] , at lease one of the following is true:

$$∃ C ∈ ( {ℂ}_{{t}_{i}} - ( {⋃}_{j = 1}^{i - 1} {ℂ}_{{t}_{j}} ⋃ {⋃}_{j = i + 1}^{n} {ℂ}_{{t}_{j}} ) ) , \\ C {∈}_{S} {ℂ}_{ϕ} or C ∈ {𝔻}_{{C}_{i}} ;$$

tᵢ appears in tuple consequences in condition (2) of this definition.

From the above discussion it is determined that both types of correlatable tuple sets can only guarantee that the fields required for the template can be provided or computed. However, further inspection of the contents of tuples is required, in order to determine whether the filtering conditions given in templates can be satisfied. In the present invention, this is realized by generating a template for each tuple in the set and then using the generated templates to inspect the contents of each tuple individually.

Assuming there are n tuples tᵢ in the correlation set [symbol] (tᵢ ε [symbol] , and [symbol] denotes the collection of all the fields required by the template), From the definition of correlation tuple set, ∀C ε [symbol] , ∃C′ ε

[symbol]

C′, C′ either is the same as C or super class of C. Therefore, for each <C′,q′> in a template, in the case of C′=C, then in the template jᵢ for tuple tᵢ, <C′,q′> is used without any changes; while in the case of C′ is super class of C, <C′,q′> need to be transformed to <C,q>, where query predicate q is transformed from q′ by replacing referenced property of C′ with property in C.

For example, considering the tuple set [symbol] for the template jₛ, two temples j₁ and j₂ are generated respectively (see Table 2). In particular, the query predicate SportsCar.price.amount<5000 in j₁ is transformed from Car.price.amount<5000 in φ, where Car is replaced by SportsCar.

Once a template jᵢ is generated for each tᵢ in T, the tuplespace server needs to test the query predicates for fields in each template and correlate tuples. In the case of field-based correlation tuple set, when inspecting the tuple using the generated template, the false result of query predicate on any tuple in the set will result in discarding the whole tuple set from further correlation processing. After testing all templates, if the tuple set is not discarded, the tuple set is correlated to one tuple.

The present system distinguishes two types of fields in T, which include unique and non-unique fields. Unique fields are the fields that are required by the template φ and only appear in one tuple in the tuple set, while non-unique fields appear in more than one tuple in the set.

For a unique field, it can be selected from a tuple. For a non-unique field, the tuplespace server prefers a tuple, which has same type of field as template required. By selecting each field required by the template, a tuple is created and delivered to the reader.

In the case of attribute-dependence correlation tuple set, another step is required on the correlated tuple: applying the dependence functions to compute the field value and testing the associated query predicate to determinate whether the generated tuple should be delivered to the reader.

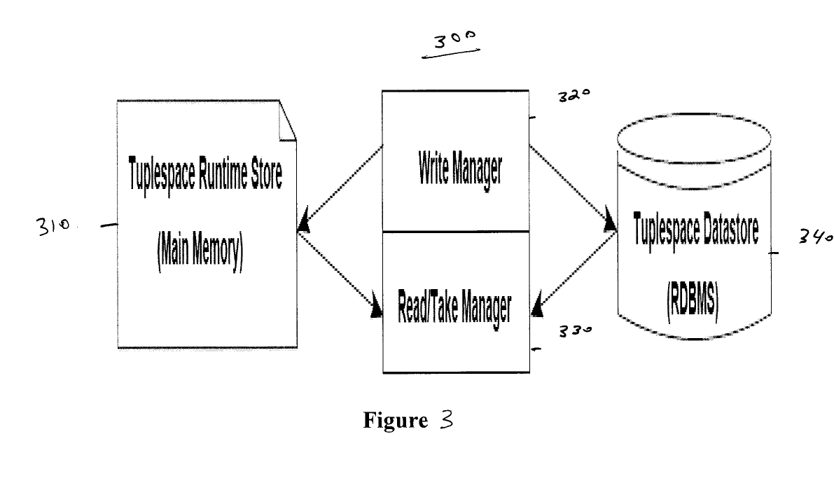

FIG. 3 illustrates the implementation of a tuplespace server 300, which includes a main memory (tuplespace runtime store) 310, a write manager 320, a read/take manager 330 and a tuplespace datastore 340.

The tuplespace server, in accordance with certain exemplary embodiments of the present invention, supports tuple correlation. This requires the tuplespace server to persist tuples when they are writing into sharespace, for possible correlation operation on them thereafter, as it is unlikely that the main memory can store all the tuples in the sharespace. Further, persistent support also allows tuplespace server restores from runtime failure, which is a key requirement for mission critical applications. Therefore, in the present invention, the tuple writer 320 manages both runtime store in main memory 310 and persistent datastore in relational database 340. When the tuple writer 320 receives a write tuple request from users, it saves the tuple object in both the runtime store 310 and the persistent datastore. In case the main memory is full, it needs to remove some tuples from Runtime Store, wherein First In First Out update algorithm is adopted. In our design, tuples in the runtime store 310 as objects have unique object IDs. As the runtime store 310 is considered as a cache for the tuplespace datastore, the system creates a tuple ID-based hash index where the unique object ID is used to locate the tuple object. Therefore, when the tuple writer 320 receives a tuple, it saves the tuple with the unique object ID, and then invokes hash functions to update the hash index. When the tuple writer 320 saves a tuple object in runtime store 3 10, it also persists the tuple object in the tuplespace datastore 340. This cache improves the system performance on retrieving tuple contents when tuple UIDs are identified.

The datastore provides persistent storage of tuples. When considering the implementation of datastore, the intuitive choice is adopting object store (i.e., persist tuples as objects). However, it is very costly when inspecting tuples' contents for tuple matching (entire tuple objects need to be deserialized in the memory). In fact, in most cases, tuple matching may only concern some attributes of tuples. For the sake of performance and scalability, instead of adopting object store, relation database is used to implement persistent datastore. Therefore, when conducting tuple matching, the inspection can only focus on the attributes that are concerted by the templates, without deserialization of entire tuple objects.

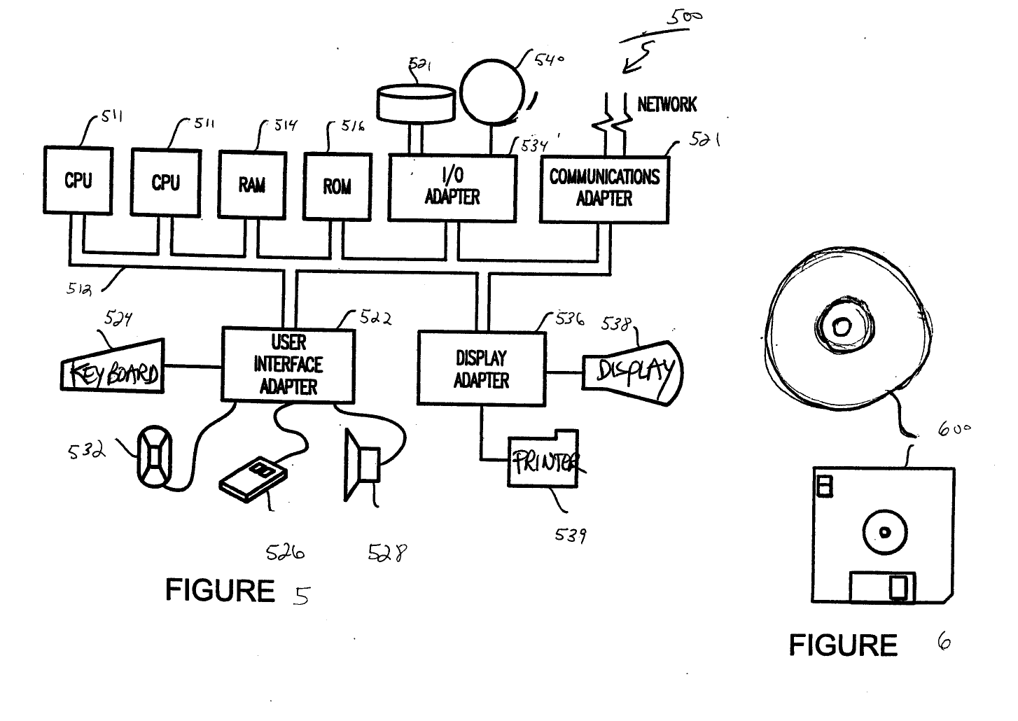

When adopting relational approach to persist tuples, mapping between tuple objects and relation tables is required. As user operations on tuples do not explicitly declare the data schema of the tuple (i.e., declaration of tuple schema is not required by the tuplespace system), a tuple can not be stored as a record in a predefined table. In the present invention, the tuplespace server separates the data organization of tuple and contents of tuples (e.g., see FIG. 5), wherein one table FieldTypes is used to store the class type information for each field in tuples, while another table TupleValues is used to store the contents of tuples. It should be noted that both class type information and the content of the tuples are stored vertically in these tables.

In particular, for table FieldTypes, each field in a tuple occupies a row. For each tuple in tuplespace a unique tupleTypeID is assigned for each type of tuple. In table TupleValues, each elementary element in a field has a record in the table and tupleID is unique for each tuple in tuplespace. Using the tupleID and fieldTypeID, the records in the table can be correlated to individual tuples. Table Dimensions (D for short) is used to store the dimension information when there exists any array type of data elements in fields. By specifying dimensionOrder and sequenceID, the datastore can store any dimension array of data in a tuple. Further, the table Types gives type information in tuplespace.

The read/take manager 330 handles tuple read/take requests from users. When it receives read/take requests, the read/take manager 330 searches for a single tuple that can match the template first. In case there are no single tuple matching the template or users required, the read/take manager 330 searches a correlation tuple set for the temple. In the system of the present invention, both semantic and correlation matching is done by generating queries on persistent data store. Details on design of query generation are omitted due to space reasons.

FIG. 5 illustrates a typical hardware configuration of an information handling/computer system in accordance with the invention and which preferably has at least one processor or central processing unit (CPU) 511.

The CPUs 511 are interconnected via a system bus 512 to a random access memory (RAM) 514, read-only memory (ROM) 516, input/output (I/O) adapter 518 (for connecting peripheral devices such as disk units 521 and tape drives 540 to the bus 512), user interface adapter 522 (for connecting a keyboard 524, mouse 526, speaker 528, microphone 532, and/or other user interface device to the bus 512), a communication adapter 534 for connecting an information handling system to a data processing network, the Internet, an Intranet, a personal area network (PAN), etc., and a display adapter 536 for connecting the bus 512 to a display device 538 and/or printer 539 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 511 and hardware above, to perform the method of the invention.

This signal-bearing media may include, for example, a RAM contained within the CPU 511, as represented by the fast-access storage for example. Alternatively, the instructions may be contained in another signal-bearing media, such as a magnetic data storage diskette 600 (FIG. 6), directly or indirectly accessible by the CPU 511. Whether contained in the diskette 600, the computer/CPU 511, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

While the invention has been described in terms of several exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

What is claimed is:

1. A tuple matching method, comprising:
conducting a plurality of types of matching techniques.

2. The method in accordance with claim 1, said method comprising semantic tuple matching and correlation tuple matching.

3. The method in accordance with claim 1, further comprising:
conducting exact tuple matching, which returns tuples having same field types as a template.

4. The method in accordance with claim 1, further comprising:
conducting semantic matching to search tuples having field types that are semantically compatible with a template.

5. The method in accordance with claim 1, further comprising:
conducting correlation matching to search a set of tuples and correlate said set of tuples to one tuple in order to match fields of a template.

6. The method in accordance with claim 1, further comprising:
conducting exact tuple matching, which returns tuples having same field types as a template;
conducting semantic matching to search tuples having field types that are semantically compatible with the template; and
conducting correlation matching to search a set of tuples and correlate said set of tuples to one tuple in order to match fields of the template.

7. The method in accordance with claim 3, wherein if there is no match from said exact tuple matching, then conducting semantic matching to search tuples having field types that are semantically compatible with the template.

8. The method in accordance with claim 7, wherein if there is no match from said exact tuple matching and said semantic matching, then conducting correlation matching to search a set of tuples and correlate said set of tuples to one tuple in order to match fields of the template.

9. A tuple matching system, comprising:
a matching unit that conducts a plurality of types of matching techniques.

10. The system in accordance with claim 9, said method comprising semantic tuple matching and correlation tuple matching.

11. The system in accordance with claim 9, further comprising:
conducting exact tuple matching, which returns tuples having same field types as a template.

12. The system in accordance with claim 9, further comprising:
conducting semantic matching to search tuples having field types that are semantically compatible with a template.

13. The system in accordance with claim 9, further comprising:
conducting correlation matching to search a set of tuples and correlate said set of tuples to one tuple in order to match fields of a template.

14. The system in accordance with claim 9, further comprising:
conducting exact tuple matching, which returns tuples having same field types as a template;
conducting semantic matching to search tuples having field types that are semantically compatible with the template; and
conducting correlation matching to search a set of tuples and correlate said set of tuples to one tuple in order to match fields of the template.

15. The system in accordance with claim 11, wherein if there is no match from said exact tuple matching, then conducting semantic matching to search tuples having field types that are semantically compatible with the template.

16. The system in accordance with claim 15, wherein if there is no match from said exact tuple matching and said semantic matching, then conducting correlation matching to search a set of tuples and correlate said set of tuples to one tuple in order to match fields of the template

17. The system in accordance with claim 9, wherein said matching unit comprises a tuplespace server.

18. A computer-readable medium tangibly embodying a program of computer-readable instructions executable by a digital processing apparatus to perform a tuple matching method, said tuple matching method comprising:
conducting a plurality of types of matching techniques.
